(19) United States
(12) Patent Application Publication
(10) Pub. No.: US 2026/0264373 A1
(43) Pub. Date: Sep. 10, 2026

(54) A FIRE RESISTANT GLAZING

(71) Applicant: Pilkington Group Limited, Lathom (GB)

(72) Inventors: Matthias AUTH, Essen (DE); Andreas POERSCH, Gelsenkirchen (DE); Guido SIEBERT

(73) Assignee: Pilkington Group Limited, Lathom (GB)

(21) Appl. No.: 19/166,336

(22) PCT Filed: Mar. 28, 2024
(86) PCT No.: PCT/GB2024/050862

§ 371 Date: Sep. 17, 2025

(30) Foreign Application Priority Data
Mar. 30, 2023 (GB) 2304746.7

(51) Int. Cl. B32B 17/10

(52) U.S. Cl. CPC B32B 17/10733; B32B 17/10128; B32B 17/1077; B32B 17/10779; B32B 2305/72; B32B 2307/3065; B32B 2307/412

(57) ABSTRACT

A fire-resistant glazing includes a laminate of at least three transparent plies and at least two transparent fire-resistant layers. Each fire-resistant layer is an interlayer for two plies, at least one fire-resistant layer includes a cured layer and at least one fire-resistant layer includes a dried layer.

The present invention relates to a fire-resistant glazing offering an improved resistance to fire performance as compared to certain conventional fire-resistant glazings.

One conventional fire-resistant glazing comprises a laminate of at least two transparent plies and at least one transparent fire-resistant layer wherein each fire-resistant layer is an interlayer for two plies.

In one such glazing, each transparent ply comprises an annealed glass pane and each transparent fire-resistant layer comprises an intumescent material which swells or foams (intumesces) on exposure of the glazing to fire to form a barrier layer that is resistant to the passage of hot gases and flame as well as heat conduction and radiation.

This glazing may include a safety glazing in order to provide a fire-resistant glazing with high impact resistance. Typically, the safety glazing comprises a laminate having two annealed glass panes and a transparent plastics film which binds the glass panes together.

Alternatively, the fire-resistant glazing may include a heat-strengthened glass pane or a fully toughened glass pane in order to provide a fire-resistant glazing with high impact resistance. The heat-strengthened or fully toughened glass pane is usually an outer pane in the laminate.

These fire-resistant glazings are used in a wide variety of fire protection glazing systems suitable for a wide variety of building or other locations.

Example fire-resistant glazings include those sold under the trade names Pyrostop® and Pyrodur® and are used in many different door and wall partitions, sloped horizontal roofs and floors and even building facades.

Example fire-resistant glazings employing a heat strengthened or fully toughened glass pane include those sold under the trade name Pyrostop® T and Pyrodur® T, and are used in ship bulkheads or in ship walls and even within ship hulls.

One method for manufacturing these fire-resistant glazings is known as the “cast-in-place” (CIP) method. The CIP method is described, for example, in international patent application WO 2008/053247 A1 (incorporated herein by reference).

In this method, an aqueous solution comprising a precursor for an intumescent material is poured into a cavity formed by an assembly comprising two opposing glass panes and a transparent near-circumferential spacer bar provided between the glass panes.

Thereafter, the cavity is completely sealed by completing the spacer bar and the aqueous solution cured in the sealed cavity to form a fire-resistant layer of an intumescent material between the glass panes.

The curing is carried out by exposing the aqueous solution to visible or UV light, or by heating the assembly to a predetermined temperature, during a predetermined period in time.

The assembly may comprise additional glass panes and circumferential seals providing for curing of the same aqueous solution in several cavities at the same time.

Fire-resistant glazings manufactured according to this method may, in particular, comprise a one, two or three CIP-cell glazing (wherein the number corresponds to the number of fire-resistant layers).

Note that in this method, a safety glazing or a heat-strengthened glass pane or fully toughened glass pane may be used in place of one or more annealed glass panes.

Another method for manufacturing the fire-resistant glazing is known as the “Pour and Dry” (PAD) process. The PAD process is described, for example, in international patent application WO 2007/118887 A1 (incorporated by reference herein).

In this method, an aqueous suspension containing an alkali metal silicate is poured onto a surface of a first glass pane and spread over substantially the whole of the surface. The suspension is heated on the first pane under carefully controlled conditions until it dries to a solid layer of intumescent material.

Thereafter, the glass surface of a second glass pane having the solid intumescent layer is laminated to the solid intumescent layer of the first glass pane.

The laminate is completed by providing a circumferential sealing tape covering substantially the whole of the thickness surfaces of the laminate.

The method may also comprise stacking additional glass panes having the same dried intumescent layer one over the other before overlaying with a cap glass pane.

Note that in this method too, a safety glazing or a heat-strengthened glass pane or fully toughened glass pane may be used in place of one or more glass pane, and in particular, the cap glass pane.

Whilst fire protection glazing systems including these fire-resistant glazings must and do meet the fire-resistance classifications of the relevant building, rail and/or maritime authorities, there is always a need to improve their protection against fire.

The present inventors note that fire-resistant glazings manufactured according to the CIP method tend to exhibit different resistance to fire performance as compared to fire-resistant glazings manufactured according to the PAD process because the intumescent materials employed in the CIP method are typically different to those employed in the PAD process.

For example, the fire-resistant glazings manufactured according to the CIP method may have better EI performance as compared to fire-resistant glazings manufactured according to the PAD process.

Furthermore, the fire-resistant glazings manufactured according to the PAD process tend to have better EW performance as compared to fire-resistant glazings manufactured according to the CIP method.

Accordingly, the designer must often choose between good EI fire performance and good EW performance when considering a fire protection glazing system.

The present invention aims to improve upon this situation by providing a fire-resistant glazing comprising cured and dried fire-resistant layers.

Accordingly, in a first aspect, the present invention provides a fire-resistant glazing comprising a laminate of at least three transparent plies and at least two transparent fire-resistant layers, wherein each fire-resistant layer is an interlayer for two plies, and wherein at least one fire-resistant layer comprises a cured layer and at least one fire-resistant layer comprises a dried layer.

Note that references herein to a cured layer are references to a layer which has been cured without drying. References herein to a dried layer are references to a layer which is formed by drying of an aqueous liquid or suspension to a solid layer.

The transparent plies may, in particular, comprise glass panes formed from an inorganic glass or organic glass. The glass panes may have any suitable geometrical shape but are preferably rectilinear or circular.

Suitable inorganic glasses include alkali silicate glass, alkali borosilicate glass and alkali aluminosilicate glass as well ceramic glasses such as that sold by Nippon Electric Glass Company under the trade name Firelite®.

Preferably, however, the inorganic glass is a soda-lime glass, such as a float glass. In that case, the tin-side of the float glass may have a silicon oxynitride or other coating for suppressing blooming at the glass surface.

In these embodiments, one or more of the glass panes may comprise a heat-strengthened glass or a fully toughened glass and the remainder comprise annealed glass.

For example, one or each outer glass pane may comprise a heat strengthened or fully tempered glass and each inner glass pane may comprise an annealed glass.

Suitable organic glasses include plastics materials such as polycarbonates and poly(methylmethacrylates) sold under a number of trade names including the trade name Perspex®.

One or each of an outer ply in the fire-resistant glazing may have one or more of an anti-reflective coating, an antibacterial coating, an antiviral coating, an easy clean coating or a self-cleaning coating on its exterior surface.

Additionally or alternatively, one or each inner ply in the fire-resistant glazing may have a low emissivity coating on its outward facing surface and/or on its inward facing surface.

Note that float glass panes having an antireflective coating are sold under the trade name Optiview™. Float glass panes having a self-cleaning coating are sold under the trade names Activ™ and SaniTise™. Float glass panes having a low emissivity coating are sold under the trade name K Glass™.

Suitable cured or dried fire-resistant layers comprise any material, intumescent or otherwise, known to the art as such.

The cured layer(s) may, in particular, comprise an organic hydrogel, an inorganic hydrogel or a hybrid, inorganic-organic hydrogel.

A suitable organic hydrogel comprises a hydrogel based on polyacrylate or polyacrylamide in water, such as the hydrogel described in WO 2014/190444A1 .

Suitable inorganic hydrogels include hydrogels based on silica sol or aerogel or on alkali metal silicate and silica sol in water.

A suitable hybrid inorganic-organic hydrogel comprises a polyacrylate-silicate hydrogel in water and is described, for example, by Mastalska-Poplawska, J. et al. in Polymer Engineering and Science, 2019, 59 (6), 1279-1287).

The dried layer(s) may, in particular, comprise an inorganic hydrogel, such as a hydrogel based on silica sol or aerogel, or a hydrogel based on alkali metal silicate and silica sol in water.

In some embodiments, both the cured layer(s) and the dried layer(s) comprise an inorganic hydrogel.

The inorganic hydrogel may be a water glass based on an alkali metal silicate, a water glass based on silica sol or a water glass based on alkali metal silicate and silica sol in water.

Preferably, the cured layer(s) comprises a first inorganic hydrogel and the dried layer(s) comprises a second inorganic hydrogel, different to the first inorganic hydrogel.

In that case, the cured layer(s) may have a different chemical composition (for example, different alkali metal or water or additive content) as compared to that of the dried layer(s).

In a preferred embodiment, the cured layer(s) comprises a potassium water glass and the dried layer(s) comprises a sodium water glass.

Suitable potassium water glasses include those commonly formed on plies by the CIP method. Preferred potassium silicate (SiO₂:K₂O) water glasses are described in international patent application WO 2008/053247A1 . These water glasses comprise organic silica sol and/or aqueous silica sol (being at least 30% by weight of solid material) such that the molar ratio of silicon dioxide to potassium oxide is at least 4.0:1 and preferably at least 4.5:1 and have a relatively low water content (35% to 43% by weight).

Suitable sodium water glasses include sodium silicate (SiO₂:Na₂O) water glasses wherein the SiO₂:Na₂O weight ratio at least 1.6:1.0 and preferably those in which that weight ratio is from 2.0:1.0 to 6.0:1.0, for example 4.0:1.0.

Other suitable sodium water glasses include those based on such sodium silicates wherein the sodium ion is partially substituted by potassium ion and/or lithium ion.

The molar ratio of sodium ion to potassium and/or lithium ion in these water glasses may be at least 2:1, and in particular, range from 1.4:1.0 to 2.5:1.0.

The water glass may, in particular, comprise a mixture of sodium silicate and potassium silicate, in which the molar ratio of sodium ion to potassium ion is at least 4.0:1.0.

These sodium water glasses are commonly formed on plies by “pour and dry” (PAD) of aqueous precursor solutions comprising the alkali metal silicate and, optionally, additives such as a polyol, for example, glycerol or diethylene glycol, an acrylate, a polysaccharide, such as cellulose or starch, or a collagen such as a gelatine to act as a cooling agent during the evaporation.

Most preferably, the inorganic (or other) hydrogel comprises at least 20% by weight of water.

In some embodiments, the cured layer(s) has a water content higher, for example, from 5 % wt to 30 % wt higher, for example, 5 % wt, 10 % wt or 15 % wt higher, than that of the dried layer(s).

The cured layer(s) may have a water content of 35 to 50 % wt, for example, 40 to 45 % wt and the dried layer(s) may have a water content of 20 to 35 % wt, for example, 22 to 28 % wt or 30 % wt.

The order of cured and dried layers within the fire-resistant glazing is not particularly limited.

In one embodiment, a top fire-resistant layer is a cured layer and the remainder of the fire-resistant layers are dried layers.

In another embodiment, a middle or intervening fire-resistant layer is a cured layer and the remainder of the fire-resistant layers are dried layers.

In a further embodiment, a top and a bottom fire-resistant layer are cured layers and the remainder of the fire-resistant layers are dried layers.

The fire-resistant glazing may, for example, comprise from four to fifteen transparent plies and from three to fourteen fire-resistant layers, wherein a top fire-resistant layer is a cured layer and the other fire-resistant layers are dried layers.

It may, for example, comprise from four to fifteen transparent plies and from three to fourteen fire-resistant layers, wherein a middle or intervening fire-resistant layer is a cured layer and the other fire-resistant layers are dried layers.

It may, for example, comprise from four to fifteen transparent plies and from three to fourteen fire-resistant layers, wherein a top and a bottom fire-resistant layers are cured layers and the other fire-resistant layers are dried layers.

In other embodiments, a middle or intervening fire-resistant layer is a dried layer and the remainder of the fire-resistant layers are cured layers.

The fire-resistant glazing may, for example, comprise from four to fifteen transparent plies and from three to fourteen fire-resistant layers, wherein a middle or intervening fire-resistant layer is a dried layer and the remainder of the fire-resistant layers are cured layers.

The cured and dried layers may have thicknesses consistent with typical thicknesses of fire-resistant layers provided in fire-resistant glazings by respectively the CIP method and the PAD process.

In some embodiments, each cured layer has the same thickness and each dried layer has the same thickness, different to the thickness of the cured layers.

In other embodiments, the cured layers have different thicknesses to each other and each dried layer has the same thickness, different to the thickness of at least one cured layer.

In other embodiments, the dried layers have different thicknesses to each other and each cured layer has the same thickness, different to the thickness of at least one dried layers.

In some embodiments, the thickness of each cured layer may, in particular, be greater or lower than the thickness of each dried layer.

In any case, each fire-resistant layer may have thickness between 0.50 mm and 22.00 mm, for example, between 1.00 mm and 6.00 mm, and preferably, between 1.20 mm and 4.00 mm.

The plies may have thicknesses consistent with those used in the CIP method and the PAD process. These thicknesses may otherwise vary in a similar way as described for the thicknesses of the fire-resistant layers.

In certain embodiments, each outer ply has thickness from 0.2 mm to 10.00 mm greater, for example, 0.5 mm, 1.00 mm, 1.50 mm, 3.00 mm or 5.0 mm greater, than the thickness of at least one inner or each inner ply. Preferably each outer glass pane has a thickness greater than that of each inner ply.

In some embodiments, the fire-resistant glazing comprises at least four plies, at least two fire-resistant layers and a cured layer, for example, two or three cured layers, comprising an epoxy resin, a polyacrylate or a polyurethane chosen to enhance the impact resistance of the glazing. Preferably, but not essentially, this cured layer comprises at least one fire retardant additive. In these embodiments, the thickness of the resin or polymer layer may be between 0.1 mm and 10 mm, for example, less than 5 mm or 1 mm.

The fire-resistant glazing need not otherwise differ from the foregoing description. The other cured layers as well as the dried layers may, in particular, comprise a water glass as described above.

Note that the inclusion of a cured layer comprising an epoxy resin, polyacrylate, or polyurethane may provide for an impact resistance equivalent to that obtained by the inclusion of a conventional safety glazing.

However, the fire-resistant glazing may, alternatively or additionally, incorporate such a safety glazing.

In that case, the fire-resistant glazing comprises at least four transparent plies, at least two transparent fire-resistant layers and a transparent adhesive plastics film, wherein the fire-resistant layers and the plastics film are each an interlayer for two plies.

When the cured layer comprising an epoxy resin, polyacrylate, or polyurethane is present, the fire-resistant glazing comprises at least five transparent plies, at least two fire-resistant layers and a transparent adhesive plastics film as well as the cured layer comprising an epoxy resin, polyacrylate or polyurethane.

The adhesive plastics film may be chosen from those known to the art. It may, in particular, comprise one or more layers of a polyvinyl acetal, especially a polyvinyl butyral, an ionomer, a polyethylene vinyl acetate, a polyurethane, a polycarbonate or an acrylic resin.

The adhesive plastics film may have thickness between 0.1 mm and 10.0 mm, for example, 0.38 mm or 0.76 mm. Suitable foils providing for such plastics interlayers are well-known and commercially available.

The position of the cured layer comprising an epoxy resin, polyacrylate, or polyurethane or the plastics film within the fire-resistant glazing is not particularly limited. The resin or polymer layer or plastics film may be an outermost interlayer or an inner interlayer. The resin or polymer layer or plastics film may, in particular, intervene between cured and dried layers or intervene between cured layers or between dried layers.

The fire-resistant glazing may further comprise a circumferential “edge” sealing tape covering at least a part or substantially the whole of the thickness surfaces of the laminate. When the sealing tape covers the whole of the thicknesses surface of the laminate it may overlay an edge portion of each of the upper and lower surfaces of the laminate.

In certain embodiments, the edge sealing tape covers a part of the thickness surfaces of the laminate corresponding to a dried layer and its adjacent plies. Of course, the edge sealing tape may cover more than one such part.

Note that in these embodiments, the parts of the thickness surfaces corresponding to cured layers are sealed by the circumferential spacer bar and, optionally, a circumferential sealing bead.

In other embodiments, corresponding to a laminate that has been cut, the edge sealing tape covers substantially the whole of the thickness surfaces of the laminate.

In alternative embodiments, also corresponding to a laminate that has been cut, the fire-resistant glazing includes a circumferential sealing arrangement which extends over substantially the whole of the thickness surfaces of the laminate and overlays an edge portion of the upper and lower surfaces of the laminate.

The sealing arrangement may, in particular, comprise a U-frame and, optionally, a thermoplastic sealant for sealing bonding of the U-frame to the thickness surfaces and edge portions of the laminate.

The U-frame may comprise a malleable metal, such as aluminium. Alternatively, it may comprise a resilient polymer material which may be used with or without a thermoplastic sealant.

The fire-resistant glazing according to the present invention may achieve EW30 performance when tested in accordance with EN 1634-1 (2014).

Alternatively or additionally, the fire-resistant glazing may achieve EI30 performance when tested in accordance with EN 1634-1 (2014).

It may, in particular, achieve EI 60, EI 90, EI 120 or EI 190 when tested in accordance EN 1634-1 (2014) and at least one of EW 60, EW 90, EW 120 or EW 190 when tested in accordance with 1634-1 (2014).

The fire-resistant glazing according to the present invention may conform to A2-s1,d1 or higher determined according to EN 13501-2 (2016).

The fire-resistant glazings may alternatively or additionally conform to A0, A15, A30, A60, BO or B15 measured according to International Maritime Organisation standard IMO A.754(18). Further, the fire-resistant glazings may conform to A1-15, A1-30, A2-15 or A2-30 measured according to European standard (railway vehicles) EN 45545-3.

In a second aspect, the present invention provides a method for the manufacture of a fire-resistant glazing, comprising:
i) preparing a first laminate and a second laminate each comprising at least two plies and at least one fire-resistant layer, wherein each fire-resistant layer is an interlayer for two plies and is a dried layer; and
ii) preparing a third laminate by curing a fire-resistant layer precursor solution between the first laminate and the second laminate to form a cured layer.

The method may, in particular, comprise preparing each of the first laminate and the second laminate using the PAD process and preparing the third laminate using the CIP method.

In that case, the preparation of each of the first laminate and the second laminate may comprise forming a dried layer on a first ply and overlaying the first fire-resistant layer with a second ply.

It may alternatively comprise forming a dried layer on multiple first plies and stacking these plies with a second ply so that each dried layer is an interlayer for two plies.

The method may further comprise providing an edge sealing tape to the thickness surfaces of each of the first and second laminates.

The method may further comprise assembling the first and second laminates with a near-circumferential spacer bar providing a cavity between the opposite surfaces of the first and second portion, filling the cavity with a curable precursor solution, sealing the cavity by completing the circumferential seal, and curing the precursor solution in the sealed cavity to form a cured layer.

The curing may be carried out by irradiating the CIP assembly with visible or UV light at room temperature. It may also be carried out by heating the CIP assembly to a temperature which does not lead to “activation” of dried layers, preferably, to a temperature less than or equal to 120° C.

The method may further comprise providing a secondary sealant to the circumferential spacer bar of the third laminate.

In some embodiments, not comprising a heat-strengthened or fully toughened glass, the first and second laminates are prepared as oversized “semifinished products”. These semi-finished products may be cut by, or to order of, a manufacturer carrying out the CIP method.

Accordingly, the method may further comprise cutting the first and/or second laminates to a desired size before preparing the third laminate.

Alternatively or additionally, the method may comprise cutting the third laminate to a desired size.

In either case, the method may further comprise providing an edge sealing tape or a circumferential sealing arrangement to the thickness surfaces of a cut laminate.

The cutting can be carried out by sawing, for example, by machine sawing, in particular, with commercially available water-cooled rotary saws.

Note that the cutting of the third laminate is advantageous to fire resistance performance because the cured layer then occupies and operates across substantially the whole of the width of the fire-resistant glazing as compared to a conventional CIP fire-resistant glazing.

Embodiments in this aspect of the invention will be apparent from those of the first aspect. Note, in particular, that each ply may comprise a glass pane and that each dried layer may comprise a sodium water glass and each cured layer may comprise a potassium water glass as described above.

In a third aspect, the present invention provides a method for the manufacture of a fire-resistant glazing, comprising:
i) preparing a first laminate comprising at least two plies and at least one fire-resistant layer, wherein the fire-resistant layer is an interlayer for two plies and is a dried layer; and
ii) preparing a second laminate by curing a fire-resistant layer precursor solution between the first laminate and an additional ply to form a cured layer.

The method may, in particular, comprise preparing the first laminate using the PAD process and preparing the second laminate using the CIP method.

The method may, in particular, comprise preparing the second laminate by curing the precursor solution between the first laminate and two additional plies to form two cured layers.

The curing may be carried out by irradiating the CIP assembly with visible or UV light at room temperature. It may also be carried out by heating the CIP assembly to a temperature which does not lead to “activation” of dried layers, preferably, to a temperature less than or equal to 120° C.
In some embodiments, not comprising a heat-strengthened or fully toughened glass, the first laminate is prepared as an oversized semifinished product. This semi-finished product may be cut by, or to order of, a manufacturer carrying out the CIP method.

Accordingly, the method may further comprise cutting the first laminate to a desired size before preparing the third laminate.

Alternatively or additionally, the method may comprise cutting the second laminate to a desired size.

In either case, the method may further comprise providing an edge sealing tape or the circumferential sealing arrangement to the thickness surfaces of the third laminate.

Embodiments in this aspect of the invention will be apparent from those of the first aspect. Note, in particular, that each ply may comprise a glass pane and that each dried layer may comprise a sodium water glass and each cured layer may comprise a potassium water glass as described above.

In a fourth aspect, the present invention provides a method for the manufacture of a fire-resistant glazing, comprising:
i) preparing a first laminate comprising at least two plies and at least one fire-resistant layer, wherein each fire-resistant layer is an interlayer for two plies and is a cured layer;
ii) preparing a second laminate by drying a fire-resistant precursor solution on at least one ply to form a dried layer, and
iii) preparing a third laminate by pressing the first laminate to the dried layer of the second laminate.

The method may comprise preparing the first laminate by the CIP method and preparing the second and third laminates using a PAD process.

The method may, in particular, comprise preparing the second laminate by drying the precursor solution on multiple plies and stacking these plies so that each dried layer will be an interlayer for two plies.

In some embodiments, not comprising a heat-strengthened or fully toughened glass, the first laminate is prepared as a semi-finished product. This semi-finished product may be cut by, or to the order of, a manufacturer carrying out the PAD process.

The method may further comprise providing an edge sealing tape or a circumferential sealing arrangement to part, or substantially the whole, of the thickness surfaces of the third laminate.

Alternatively, the method may comprises cutting the third laminate to a desired size and providing an edge sealing tape or a circumferential sealing arrangement to the thickness surfaces of the third laminate.

Embodiments in this aspect of the invention will be apparent from those of the first aspect. Note, in particular, that each ply may comprise a glass pane and that each dried layer may comprise a sodium water glass and each cured layer may comprise a potassium water glass as described above.

The method may comprise drying a fire-resistant precursor solution on a CIP cell containing a cured layer. In that case, the drying is carried out at a temperature which does not lead to “activation” of cured layers, preferably, at a temperature less than or equal to 120° C.

In a fifth aspect, the present invention provides a method for the manufacture of a fire-resistant glazing, comprising:
i) preparing a first laminate comprising at least two plies and at least one fire-resistant layer, wherein each fire-resistant layer is an interlayer for two plies and is a cured layer;
ii) preparing a second laminate comprising at least two plies and at least one fire-resistant layer, wherein each fire-resistant layer is an interlayer for two plies and is a dried layer, and
iii) preparing a third laminate by laminating the first laminate to the second laminate with a plastics film.

The method may, in particular, comprise preparing the first laminate using the CIP method and preparing the second laminate using the PAD process.

The lamination of the first laminate to the second laminate may comprise heating a plastics film, such as a PVB foil, between the first and second laminates at pressure and temperature which does not lead to the “activation” of the dried and cured layers, for example, a temperature less than or equal to 120° C. at 1 atmosphere.

The lamination may, in particular, comprise heating a polyvinylbutyral foil between the first laminate and the second laminate to a temperature less than or equal to 120° C. at 1.2 bar pressure during at least 5 hours.

The method may further comprise cutting the third laminate to a desired size and providing an edge sealing tape or a circumferential sealing arrangement to the thickness surfaces of the third laminate.

Embodiments in this aspect of the invention will be apparent from those of the first aspect. Note, in particular, that each ply may comprise a glass pane and that each dried layer may comprise a sodium water glass and each cured layer may comprise a potassium water glass as described above.

Note that in the foregoing methods, curing absent a dried layer and drying absent a cured layer may be carried out at temperatures which are typical to the CIP method or to the PAD process as the case may be.

In a sixth aspect, the present invention provides a product for a fire protection system, comprising the fire-resistant glazing of any one of the first to fifth aspects.

The product may be one providing for use of the glazing as a fixed glazing or within a partial or full-sized fire door, a wall, a roof, a floor a bulkhead or a vehicle.

Alternatively, the product may be a semi-finished product for use with other products providing security installations.

Embodiments in this aspect of the invention will be apparent from those of the first aspect. Note, in particular, that each ply may comprise a glass pane and that each dried layer may comprise a sodium water glass and each cured layer may comprise a potassium water glass as described above.

In a seventh aspect, the present invention provides a fire protection system, including the fire-resistant glazing of the first aspect.

The fire protection system may, in particular, comprise an insulated glazing unit (IGU), such as a double or triple glazing in which the fire-resistant glazings are separated by a gap containing air or an inert gas.

The IGU may be a triple glazing unit comprising a first fire-resisting glazing comprising three plies and two cured layers which is located between two second fire-resisting glazings comprising two plies and a dried layer.

Alternatively, the IGU may be a double glazing unit comprising a fire-resistant glazing having four plies and three fire resistant layers in combination with a fire-resistant glazing having four plies, two fire resistant layers and a plastics film.

The gap(s) between adjacent fire-resistant glazings may be provided by, for example, a sealing arrangement including a circumferential spacer bar. The gap may be divided into compartments by, for example, pillars provided between opposing surfaces of the fire-resistant glazings.

Embodiments in this aspect of the invention will be apparent from those of the first aspect. Note, in particular, that each ply may comprise a glass pane and that each dried layer may comprise a sodium water glass and each cured layer may comprise a potassium water glass as described above.

The present invention will now be described in more detail with refence to the following non-limiting embodiments and the accompanying drawings in which:

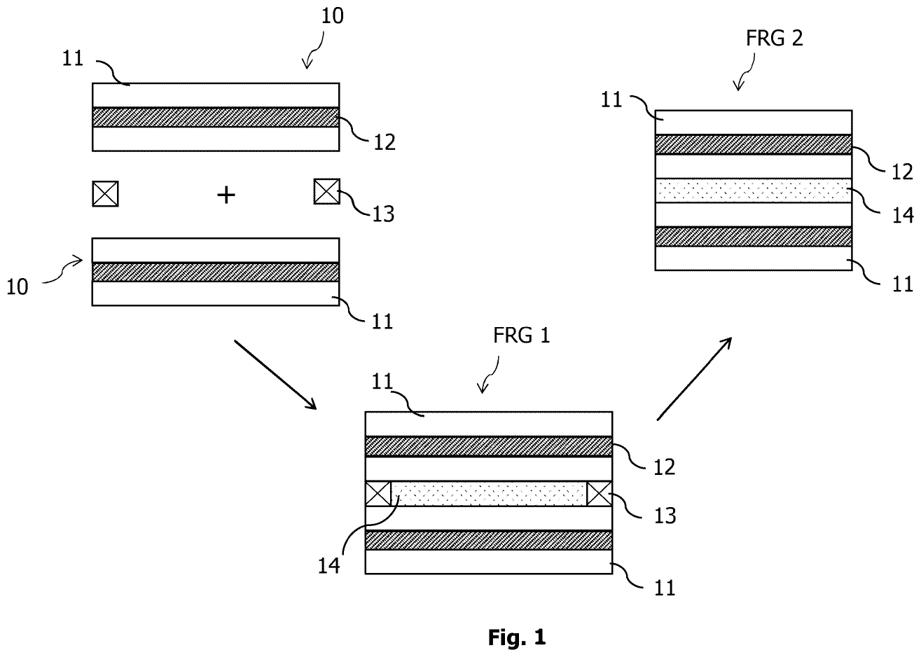

FIG. 1 is a scheme illustrating a method for the manufacture of a fire-resistant glazing according to the one embodiment of the present invention;

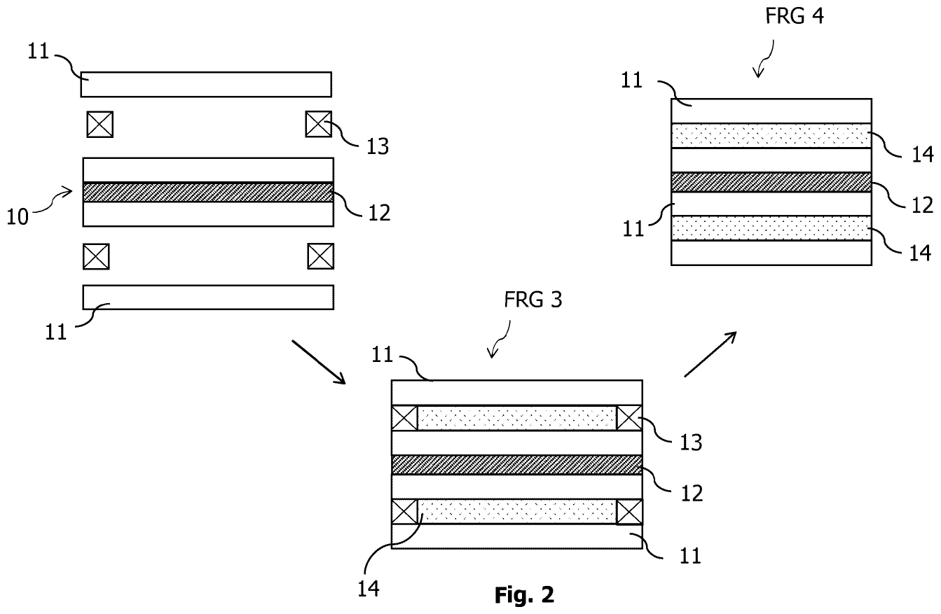

FIG. 2 is a scheme illustrating a method for the manufacture of a fire-resistant glazing according to another embodiment of the present invention;

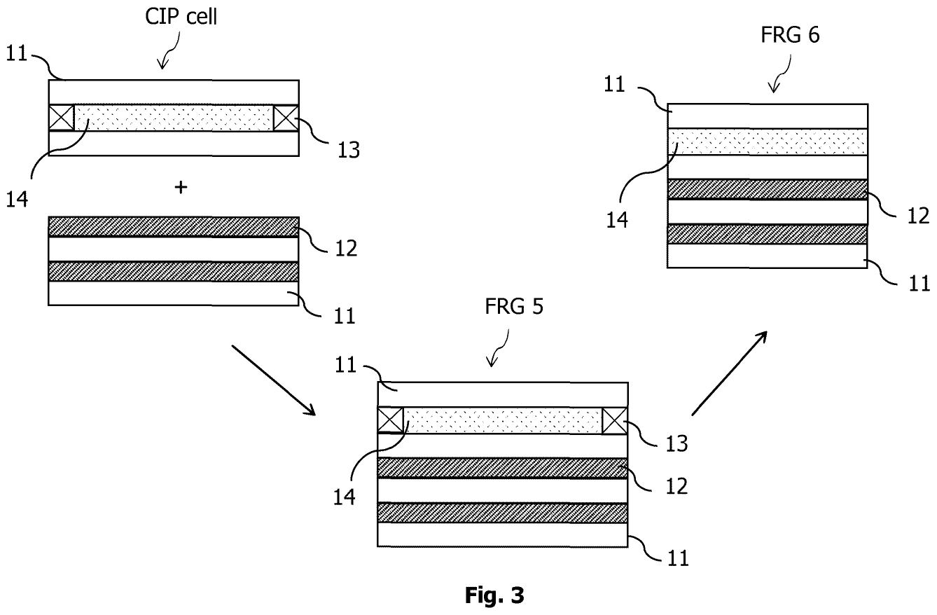

FIG. 3 is a scheme illustrating a method for the manufacture of a fire-resistant glazing according to still another embodiment of the present invention;

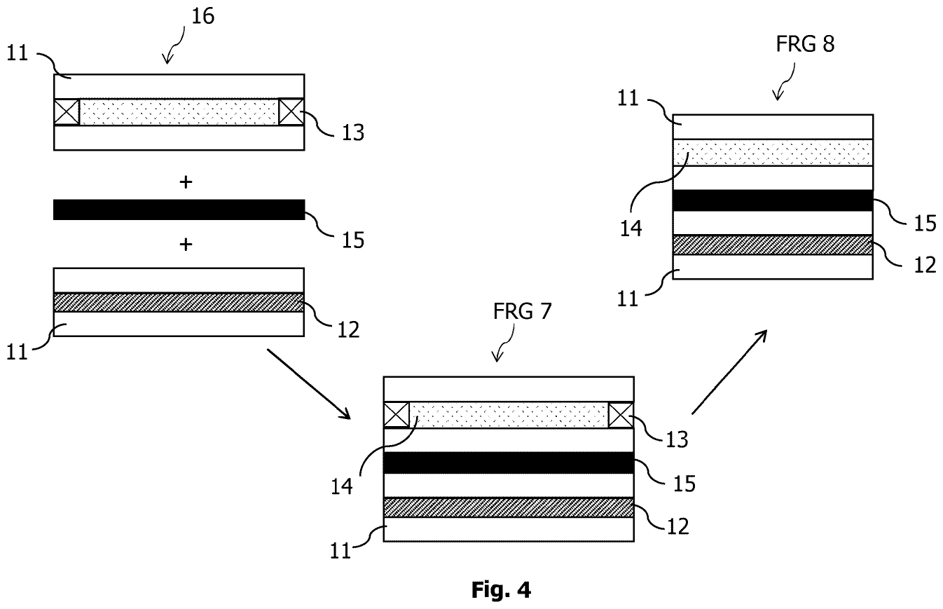

FIG. 4 is a scheme illustrating a method for the manufacture of a fire-resistant glazing according to yet another embodiment of the present invention;

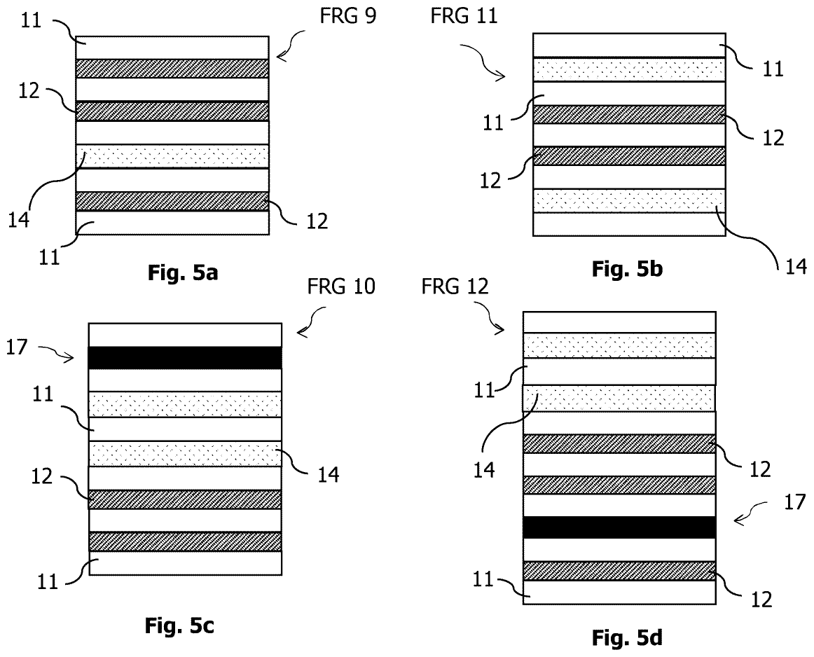

FIG. 5a) to d) show cross-sectional views of fire-resistant glazings according to several other embodiments of the present invention;

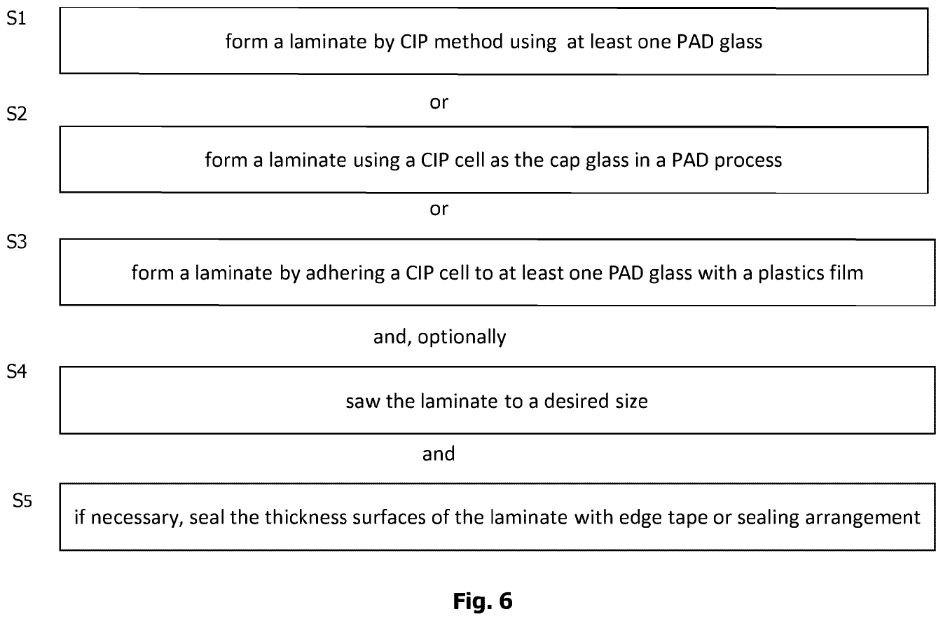

FIG. 6 is a flow diagram generally outlining the foregoing methods for the production of fire-resistant glazings; and

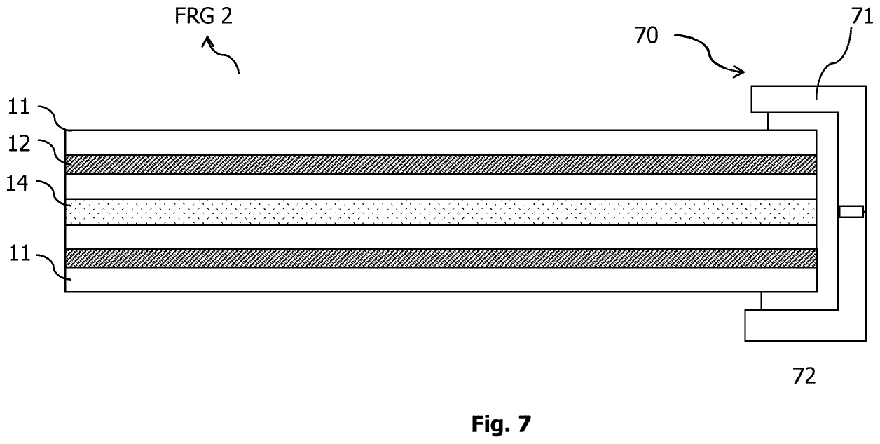

FIG. 7 is a cross-sectional view of part of a fire-resistant glazing including a sealing arrangement according to one embodiment of the present invention.

FIG. 1 outlines a method for the manufacture of fire-resistant glazings according to one embodiment of the present invention.

As may be seen, the method utilises a first PAD glass 10 comprising two rectangular glass panes 11 separated by a sodium water glass 12 and a second PAD glass comprising two rectangular glass panes 11 separated by the same sodium water glass 12.

The first and second PAD glasses 10 are obtained by drying a layer of a sodium water glass 12 on a first glass pane 11, overlaying the dried layer 12 with a second glass pane 11 and gluing an edge sealing tape (not shown) on the thickness surfaces of the PAD glass.

The method comprises assembling the first and second PAD glasses 10 together with a near-circumferential spacer bar 13 so as to provide a cavity (not shown) between opposite faces of the first and second PAD glasses 10.

The method further comprises introducing a precursor solution for a potassium water glass into the cavity, sealing the cavity by completing the spacer bar 13 and curing the precursor solution within the sealed cavity to a potassium water glass 14 by heating without activating the sodium water glass layers 12 in the PAD glasses 10.

When the spacer bar 13 is inset the panes 11, the method may also provide a circumferential bead of a secondary sealant (not shown) adjacent the spacer bar.

The fire-resistant glazing FRG 1 so obtained comprises an upper PAD glass 10 and a lower PAD glass 10 which together define a CIP cell in which the circumferential spacer bar 13 is adjacent or near to the edges of the glass panes 11.

When the laminate does not include a heat strengthened or fully toughened glass pane 11, the laminate may be cut along one or more circumferential edges-removing the edge tape and circumferential spacer bar 13 (and bead) along those edges.

In that case, the method further comprises sawing the laminate along one or more circumferential edges and gluing an edge sealing tape (not shown) or providing a sealing arrangement over substantially the whole of one or more the thickness surfaces of the laminate.

The fire-resistant glazing FRG 2 so obtained comprises an upper PAD glass 10 and a lower PAD glass 10 having a fire-resistant layer 14 therebetween.

One sealing arrangement for the fire-resistant glazing FRG 2, shown in FIG. 7 as 70, comprises an aluminium frame 71 which extends around the periphery of the glazing and overlaps an edge portion of exterior facing surfaces of the glass panes 11.

FIG. 2 outlines a method for the manufacture of a fire-resistant glazing according to another embodiment of the present invention.

As may be seen, the method utilises a PAD glass 10 and two additional glass panes 11.

The method comprises assembling the PAD glass 10 and the glass panes 11 together with two near-circumferential spacer bars 13 so as to provide two cavities (not shown) between opposing faces of the PAD glass 10 and the glass panes 11.

The method further comprises introducing a precursor solution for a potassium water glass into the cavities, sealing the cavities by completing the spacer bars 13 and curing the precursor solutions within the sealed cavities to a solid potassium water glass 13 by heating without activating the sodium water glass layer 12 in the PAD glass 10.

When the spacer bars 13 are inset the panes 11, the method may also provide a circumferential bead of a secondary sealant (not shown) adjacent each spacer bar.

The fire-resistant glazing FRG 3 so obtained comprises a PAD glass 10 and glass panes 11 which together define a CIP cell in which the circumferential spacer bar 13 is adjacent the edges of the glass panes 11.

When the laminate does not include a heat strengthened or fully toughened glass pane 11, the laminate may be cut along one or more circumferential edges-removing the edge tape and circumferential spacer bar 13 along those edges.

In that case, the method further comprises cutting the laminate along one or more circumferential edges and gluing a circumferential edge tape (not shown) or providing a sealing arrangement over substantially the whole of one or more edge surfaces of the laminate.

The fire-resistant glazing FRG 4 so obtained comprises a PAD glass 10 sandwiched between two cured CIP layers.

Note that the foregoing methods may alternatively cure the precursor solution for potassium water glass by irradiating the assembly with visible and/or UV light.

FIG. 3 outlines a method for the manufacture of fire-resistant glazings according to still another embodiment of the present invention.

As may be seen, the method comprises stacking two glass panes 11 having a dried layer of a sodium water glass 12 by pressing the glass surface of one onto the dried layer 12 of the other and overlaying a CIP cell on the remaining dried layer 12.

The method may further comprise providing an edge sealing tape (not shown) on that part of the thickness surfaces of the laminate corresponding to a PAD glass 10.

The fire-resistant glazing FRG 5 so obtained comprises a PAD glass 10 and a CIP cell which share a glass pane 11.

When the laminate does not include a heat strengthened or fully toughened glass pane 11, the laminate may be cut along one or more circumferential edges-removing the edge tape and circumferential spacer bar 13 along those edges.

In that case, the method further comprises cutting the laminate along one or more circumferential edges and gluing an edge sealing tape (not shown) or providing a sealing arrangement over substantially the whole of one or more edge surfaces of the laminate.

The fire-resistant glazing FRG 6 so obtained comprises a pad glass 10 provided with an upper cured layer 14.

FIG. 4 outlines a method for the manufacture of fire-resistant glazings according to yet another embodiment of the present invention.

The method comprises laminating a PAD glass 10 with a CIP cell 16 by heating an adhesive polyvinyl acetal foil 15 therebetween without activating the dried layer 12 or the cured layer 14.

The fire-resistant glazing FRG 7 so obtained comprises a PAD glass 10 and a CIP cell 16 which are joined together by a transparent polymer layer 15.

When the laminate does not include a heat strengthened or fully toughened glass pane 11, the laminate may be cut along one or more of its circumferential edges-removing the edge tape and circumferential spacer bar 13 along those edges.

In that case, the method further comprises cutting the laminate along one or more of its circumferential edges and gluing an edge sealing tape (not shown) or providing a sealing arrangement over substantially the whole of one or more edge surfaces of the laminate.

The fire-resistant glazing FRG 8 so obtained also comprises a pad glass 10 provided with a cured layer 14.

The foregoing methods may be adapted by providing that additional CIP cells 10, panes 11, spacer bars 13 and adhesive polyvinyl acetal foil 15 are used. An additional CIP cell 10 may contain an epoxy resin, polyacrylate or polyurethane rather than the potassium water glass.

FIG. 5 shows some fire-resistant glazings which can be obtained by the aforementioned methods.

FIG. 5a shows a fire-resistant glazing FRG 9 obtained by the method outlined in FIG. 1. The fire-resistant glazing is formed from a first PAD glass 10 having two rectangular glass panes 11 and a single dried layer of sodium water glass 12 and a second PAD glass 10 having four rectangular glass panes and two dried layers of sodium water glass 12. The fire-resistant glazing is includes a cured layer 14 towards the middle and a sealing edge tape (not shown) which seals the fire-resistant layers against ingress of water.

FIG. 5b shows a fire-resistant glazing FRG 10 obtained by the method outlined in FIG. 2. The fire-resistant glazing FRG 10 is formed from a PAD glass 10 having four rectangular glass panes and two dried layers of sodium water glass 12. The fire-resistant layer includes a cured layer 14 at the top and bottom as well as an edge sealing tape (not shown) which seals the fire-resistant layers against ingress of water.

FIG. 5c shows a fire-resistant glazing FRG 11 obtained by the method outlined in FIG. 3. The fire-resistant glazing FRG 11 is formed by overlaying a CIP glass comprising two CIP cells formed from a safety glass 17 and two glass panes 11 on a dried layer formed on a PAD glass and providing an edge sealing tape (not shown) which seals the fire-resistant layers against ingress of water.

FIG. 5d shows a fire-resistant glazing FRG 12 obtained by the method outlined in FIG. 3. The fire-resistant glazing FRG 12 is formed by overlaying a CIP glass comprising two CIP cells on a dried layer formed on a PAD glass 10 incorporating a safety glass 17 and providing a circumferential edge tape (not shown) which seals the fire-resistant layers against ingress of water.

FIG. 6 is a flow diagram summarising the aforementioned methods for manufacture of fire-resistant glazings comprising cured and dried layers.

As may be seen, the manufacture comprises the steps(S) of forming a laminate by a cast-in-place (CIP) method using at least one PAD glass (S1) or by using a CIP cell as the cap glass (S2) in a PAD process or by laminating a PAD cell to a CIP cell with an adhesive plastics film (S3).

The manufacture may or may not further comprise sealing the thickness surfaces of the newly formed laminate.

In some embodiments, the manufacture uses one or more PAD glasses to form one or more CIP cells and does not require the step of sealing the thickness surfaces of the laminate.

In other embodiments, the manufacture uses one or more cut PAD glasses to form one or more CIP cells and requires the step of sealing that part of the thickness surfaces of the laminate corresponding to the cut PAD glasses.

In still other embodiments, the manufacture uses a CIP cell instead of a glass pane in a PAD process and requires the step sealing that part of the laminate corresponding to the PAD glasses.

In still other embodiments, the manufacture uses one or more PAD glasses to form one or more CIP cells and requires cutting of the laminate and sealing the whole of the thickness surfaces of the laminate.

The present invention provides for the combination of PAD layers and CIP layers within a fire-resistant glazing. It offers fire-resistant glazings achieving better protection than fire-resistant glazings having only CIP layers or PAD layers.

The presence of an EW optimised portion corresponding to dried layers in the outer part of a glazing with an EI optimised portion corresponding to cured layers in the center of the glazing is particularly advantageous.

Further, the present invention also enables special advantages in terms of security properties that can be achieved by fire-resistant glazings.

It is possible to use CIP cells including organic polymers or resins which may provide that the fire-resistant glazings with superior impact performance as compared to fire-resistant glazings incorporating safety glasses having only cured layers or dried layers.

1.-21. (canceled)

22. A fire-resistant glazing comprising a laminate of at least three transparent plies and at least two transparent fire-resistant layers, wherein each fire-resistant layer is an interlayer for two plies, and wherein at least one fire-resistant layer comprises a cured layer and at least one fire-resistant layer comprises a dried layer.

23. A fire-resistant glazing according to claim 22, wherein each of the cured layer and the dried layer comprises a hydrogel.

24. A fire-resistant glazing according to claim 22, wherein the cured layer comprises an organic hydrogel or a hybrid organic-inorganic hydrogel and the dried layer comprises and inorganic hydrogel.

25. A fire-resistant glazing according to claim 22, wherein the cured layer comprises a first inorganic hydrogel and the dried layer comprises a second inorganic hydrogel, different to the first inorganic hydrogel.

26. A fire-resistant glazing according to claim 25, wherein the cured layer comprises a potassium water glass and the dried layer comprises a sodium water glass.

27. A fire-resistant glazing according to claim 22, wherein the cured layer has a water content lower than that of the dried layer.

28. A fire-resistant glazing according to claim 22, comprising consecutive cured layers and consecutive dried layers.

29. A fire-resistant glazing according to claim 22, comprising alternate cured and dried layers.

30. A fire-resistant glazing according to claim 22, comprising at least four plies, at least two fire-resistant layers and a cured layer comprising one or more of an epoxy resin, a polyacrylate or a polyurethane.

31. A fire-resistant glazing according to claim 22, comprising at least four plies, at least two fire-resistant layers and an adhesive plastics film wherein the adhesive plastics film is also an interlayer for two plies.

32. A fire-resistant glazing according to claim 31, wherein the plastics film comprises one or more of a polyvinyl acetal, an ionomer, a polyethylene vinyl acetate, a polyurethane, a polycarbonate or an acrylic resin.

33. A fire-resistant glazing according to claim 30, wherein the cured layer of epoxy resin, polyacrylate or polyurethane or the adhesive plastics film is a middle or outermost layer in the laminate.

34. A fire-resistant glazing according to claim 22, further comprising a circumferential sealing tape on the thickness surfaces of the laminate.

35. A fire-resistant glazing according to claim 33, further comprising a sealing arrangement comprising a U-frame and, optionally a thermoplastic sealant.

36. A fire-resistant glazing according to claim 22, providing EW30 performance or EI30 performance when tested in accordance with EN 1634-1 (2014).

37. A method for the manufacture of the fire-resistant glazing according to claim 22, comprising:
i) preparing a first laminate and a second laminate each comprising at least two plies and at least one fire-resistant layer, wherein each fire-resistant layer is an interlayer for two plies and is a dried layer; and
ii) preparing a third laminate by curing a fire-resistant layer precursor solution between the first laminate and the second laminate to form a cured layer.

38. A method for the manufacture of the fire-resistant glazing according to any claim 22, comprising:
i) preparing a first laminate comprising at least two plies and at least one fire-resistant layer, wherein the fire-resistant layer is an interlayer for two plies and is a dried layer; and
ii) preparing a second laminate by curing a fire-resistant layer precursor solution between the first laminate and an additional ply to form a cured layer.

39. A method for the manufacture of a fire-resistant glazing according to claim 22, comprising:
i) preparing a first laminate comprising at least two plies and at least one fire-resistant layer, wherein each fire-resistant layer is an interlayer for two plies and is a cured layer;
ii) preparing a second laminate by drying a fire-resistant precursor solution on at least one ply to form a dried layer, and
iii) preparing a third laminate by pressing the first laminate to the dried layer of the second laminate.

40. A method for the manufacture of a fire-resistant glazing according to claim 22, comprising:
i) preparing a first laminate comprising at least two plies and at least one fire-resistant layer, wherein each fire-resistant layer is an interlayer for two plies and is a cured layer;
ii) preparing a second laminate comprising at least two plies and at least one fire-resistant layer, wherein each fire-resistant layer is an interlayer for two plies and is a dried layer, and
iii) preparing a third laminate by laminating the first laminate to the second laminate.

41. An insulated glazing unit (IGU) comprising at least two fire-resistant glazing according to claim 22.
